(19) United States
(12) Patent Application Publication
(10) Pub. No.: US 2010/0017312 A1
(43) Pub. Date: Jan. 21, 2010

(54) MATERIAL DELIVERY SYSTEM TO ONE OR MORE UNITS AND METHODS OF SUCH DELIVERY

(76) Inventor: Martin Evans, Tolland, CT (US)

Correspondence Address: PATTERSON & SHERIDAN, LLP / INTERCAT EQUIPMENT, 3040 Post Oak Boulevard, Suite 1500, Houston, TX, 77056-6582, US

(21) Appl. No.: 12/504,882

(22) Filed: Jul. 17, 2009

Related U.S. Application Data
(60) Provisional application No. 61/081,646, filed on Jul. 17, 2008.

(51) Int. Cl. G06Q 10/00; B01J 8/18; C10G 11/00; G06Q 50/00

(52) U.S. Cl. 705/28; 422/145; 208/113

(57) ABSTRACT

Material delivery systems and methods are disclosed. A material delivery system includes a delivery vessel and at least one dispense mechanism outlet. The delivery vessel is configured to deliver material to at least one unit, with the proviso that when the unit is an FCC unit, the unit includes a plurality of units. The at least one dispense mechanism outlet is configured to couple the delivery vessel to the at least one unit. A method includes providing a material to at least one unit. The method includes dispensing material from a delivery vessel, wherein a metering device provides a metric indicative of the dispensed material with respect to at least a unit, and delivering the metered material to at least one unit via at least one dispense mechanism outlet of the delivery vessel coupled to the at least one unit. Another method includes providing a material to a plurality of units.

### CROSS-REFERENCE TO RELATED APPLICATIONS

This application claims priority to provisional application 61/081,646 filed Jul. 17, 2008 titled MATERIAL DELIVERY SYSTEM TO ONE OR MORE UNITS AND METHODS OF SUCH DELIVERY.

This application is related to U.S. patent application Ser. No. 11/168,685 filed Jun. 28, 2005 (Attorney Docket No. CAT/006D1) which is a divisional of U.S. Pat. No. 6,974,559 issued Jan. 13, 2005 (Attorney Docket No. CAT/006), U.S. patent application Ser. No. 11/276,899, filed Mar. 17, 2006, entitled “Multi-Catalyst Injection System” by Evans (Attorney Docket No. CAT/008C1) and U.S. patent Application Ser. No. 11/276,903, filed Mar. 17, 2006, entitled “Mobile Fluid Catalytic Cracking Injection System” by Evans (CAT/009C1), all of which are hereby incorporated by reference in their entireties.

### BACKGROUND OF THE INVENTION

1. Field of the Invention

The invention generally relates to material delivery systems and methods of metering and delivering a material to one or more units. Particularly, the invention relates to material delivery systems and methods of metering and delivering one or more materials to multiple units. The invention also relates to providing one or more materials to one or more, with the proviso that when the unit is an FCC unit, the unit includes a plurality of units.

2. Description of the Related Art

Some industrial processes, such as fluid catalytic cracking systems, deliver one or more specified amount of a material such as a catalyst(s) or additives to a single FCC unit. FIG. 1 is a simplified schematic of one embodiment of a conventional fluid catalytic cracking system 130. The fluid catalytic cracking system 130 includes a FCC unit 110 coupled to catalyst or additive addition system, etc. 100, an oil feed stock source 104, an exhaust system 114 and a distillation system 116. Catalyst from the catalyst addition system 100 and oil from the oil feed stock source 104 are delivered to the FCC unit 110.

The catalyst addition system 100 may include a main catalyst injector 102 and one or more additive injectors 106. The main catalyst injector 102 and the additive injector 106 are coupled to the FCC unit 110 by a process line 122. A fluid source, such as a blower or air compressor 108, is coupled to the process line 122 and provides pressurized fluid, such as air, that is utilized to carry the various products, such as a catalyst, additive, equilibrium spent catalyst, catalyst fines, etc. from the injectors 102, 106 through the process line 122 where they are combined with oil from the oil feed stock source 104 and delivered into the FCC unit 110.

FIG. 2 is an embodiment of a conventional additive injector 106. The additive injector 106 includes a pressure vessel 220 and a low pressure storage vessel 240. Such conventional additive injectors do not deliver one or more materials to one or more units or industrial processes other than to a single FCC unit. Such conventional additive injectors also do not deliver one or more materials to multiple FCC units.

Thus, a need still exists for a method and apparatus or system capable of delivering one or more materials to one or more industrial process units. A need also still exists for a method and apparatus or system capable of delivering one or more materials to a plurality of FCC units.

### SUMMARY OF THE INVENTION

The purpose and advantages of embodiments of the invention will be set forth and apparent from the description that follows, as well as will be learned by practice of the embodiments of the invention. Additional advantages will be realized and attained by the methods and systems particularly pointed out in the written description and claims hereof, as well as from the appended drawings.

Material delivery systems and methods of delivering one or more materials to one or more units are disclosed. Accordingly, one aspect of the invention includes a material delivery system. The material delivery system includes a delivery vessel and at least one dispense mechanism. The delivery vessel is configured to deliver material to at least one unit. The at least one dispense mechanism is configured to be couple the delivery vessel to the at least one unit, with the proviso that when the unit is an FCC unit, the unit includes a plurality of units.

A second aspect of the invention includes a method of providing a material to at least one unit. The method includes dispensing material from a delivery vessel, wherein a metering device provides a metric indicative of the dispensed material with respect to the at least a unit; and delivering the metered material to the at least one unit via at least one dispense mechanism outlet of the delivery vessel coupled to the at least one unit; with the proviso that when the unit is an FCC unit, the at least one dispense mechanism outlet of the delivery vessel are coupled to a plurality of units.

A third aspect of the invention includes a method of providing a material to a plurality of units. The method includes: dispensing a metered metric of material from a delivery vessel to a first unit via a dispense mechanism outlet of a delivery vessel; and dispensing a metered metric of material to a second unit via a dispense mechanism outlet of the delivery vessel.

The accompanying figures, which are incorporated in and constitute part of this specification, are included to illustrate and provide a further understanding of the method and system of the invention. Together with the description, the figures serve to explain the principles of the invention. It is contemplated that features from one embodiment may be beneficially incorporated in other embodiments without further recitation.

### BRIEF DESCRIPTION OF THE DRAWINGS

FIG.1 is schematic view of a conventional fluid catalytic cracking system;

FIG. 2 is a elevation view of a conventional catalyst injector having a low pressure storage vessel;

FIG. 3A is a schematic view of a material delivery system with a plurality of dispense mechanisms outlets coupled separately to a plurality of units, in accordance with an embodiment of the invention;

FIG. 3B is a schematic view of a material delivery system with a plurality of dispense mechanisms outlets coupled to a plurality of units, wherein at least one of the dispense mechanisms outlets is selectively coupled to at least two of the plurality of units, in accordance with another embodiment of the invention;

FIG. 3C is a schematic view of a material delivery system with a plurality of dispense mechanisms outlets coupled separately to a single unit in accordance with an embodiment of the invention;

FIG. 3D is another schematic view of a material delivery system with a plurality of dispense mechanisms outlets coupled to a single unit, in accordance with an embodiment of the invention

FIG. 4A is a schematic view of a material delivery system in accordance with an embodiment of the invention;

FIG. 4B is a schematic view of a material delivery system in accordance with another embodiment of the invention;

FIG. 4C is a schematic view of a material delivery system in accordance with another embodiment of the invention;

FIG. 4D is an upper level schematic diagram of a material delivery system in accordance with another embodiment of the invention;

FIG. 5 is a schematic view of a fluid catalytic cracking system coupled to a material delivery system with a plurality of separate material storage containers in accordance with an embodiment of the invention;

FIG. 6 is a schematic view of a fluid catalytic cracking system coupled to a material delivery system with the delivery vessel having at least two compartments in accordance with an embodiment of the invention;

FIG. 7 is a schematic view of a fluid catalytic cracking system coupled to a_mobile material delivery system in accordance with an embodiment of the invention;

FIG. 8 is a flow diagram of a method of providing a material to a unit in accordance with an embodiment of the invention;

FIG.9 is another flow diagram of another method of providing material to a unit in accordance with an embodiment of the invention; and

FIG.10 is another flow diagram of another method of providing material to a unit in accordance with an embodiment of the invention.

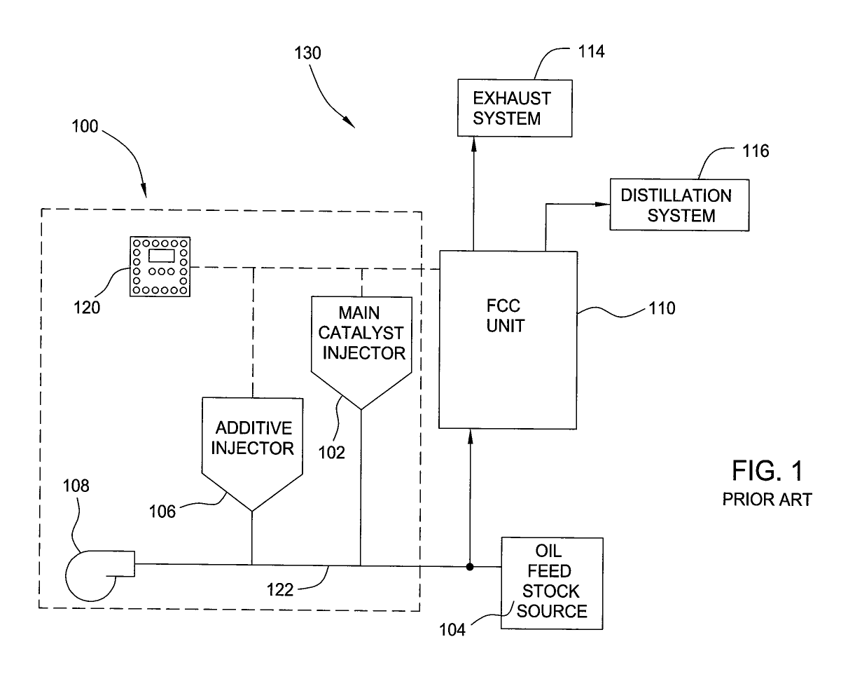

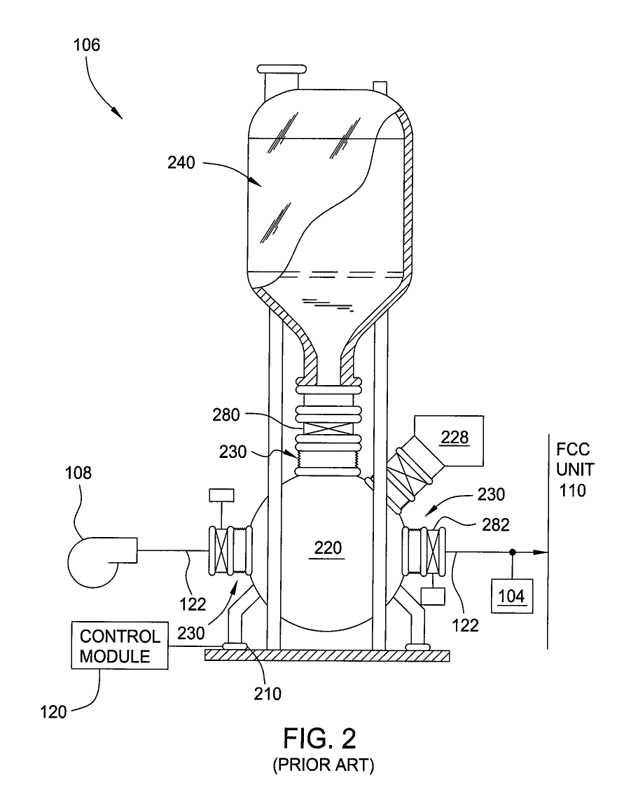

To facilitate understanding, identical reference numerals have been used, wherever possible, to designate identical elements that are common to the figures.

### DETAILED DESCRIPTION

Reference will now be made in detail to exemplary embodiments of the invention, which are illustrated in the accompanying figures and examples. Referring to the drawings in general, it will be understood that the illustrations are for the purpose of describing a particular embodiment of the invention and are not intended to limit the invention thereto.

Whenever a particular embodiment of the invention is said to comprise or consist of at least one element of a group and combinations thereof, it is understood that the embodiment may comprise or consist of one or more of any of the elements of the group, either individually or in combination with any of the other elements of that group. Furthermore, when any variable or part occurs more than one time in any constituent or in formula, its definition on each occurrence is independent of its definition at every other occurrence. Also, combinations of parts and/or variables are permissible only if such combinations result in stable apparatus, system or method. The invention provides material delivery systems and methods of metering and delivering material to one or more units.

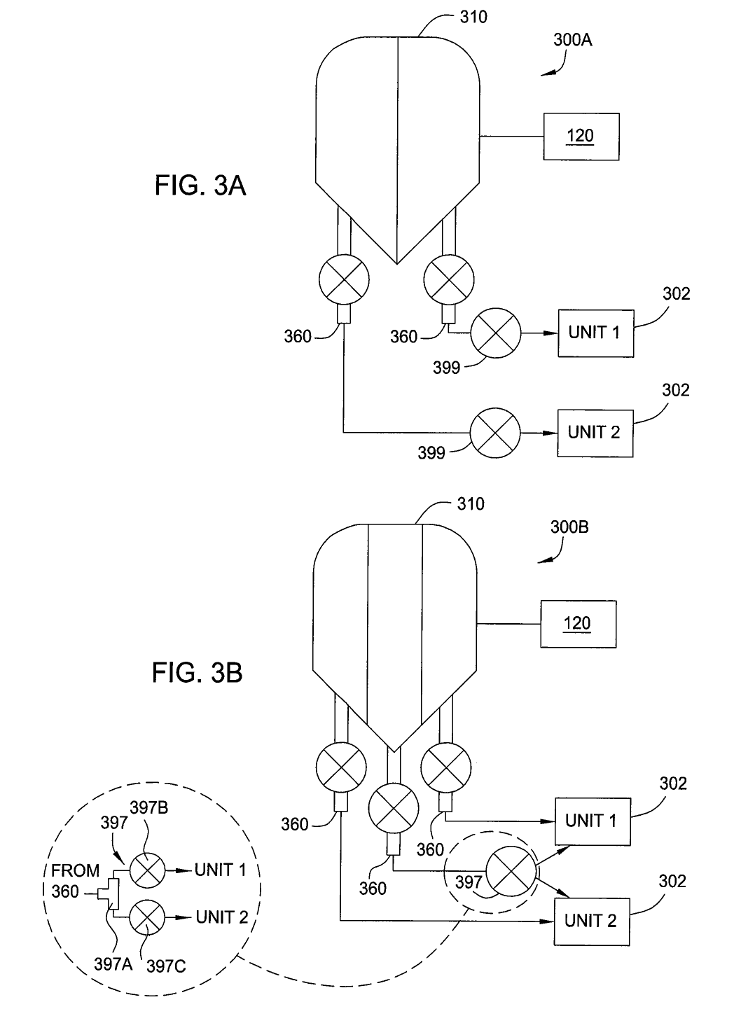

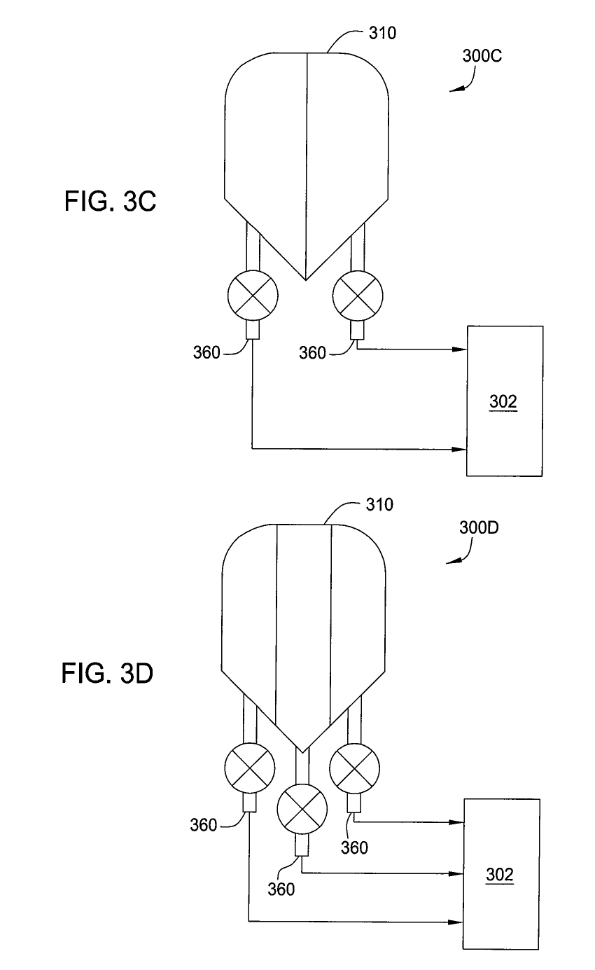

With reference to FIG. 3A, there is shown one embodiment of a material delivery system 300A. The material delivery system 300A includes one or more delivery vessels 310 and one or more dispense mechanism outlets 360. The one or more dispense mechanism outlets 360 are configured to couple the vessel 310 to one or more units 302 and the one or more dispense mechanism outlets 360 are configured to deliver material to the one or more units 302. When the unit is an FCC unit, the unit comprises a plurality of units.

In one embodiment, the delivery vessel is configured to deliver material to a plurality of units. In one embodiment, the delivery vessel includes a plurality of dispense mechanism outlets 360 adapted for coupling to the plurality of units 302. In one embodiment, a respective dispense mechanism outlet 360 is coupled to the one or more respective units 302. In another embodiment, a dispense mechanism outlet 360 is adapted for coupling to the plurality of units sequentially, wherein the outlet is alternatively sequentially configured to be coupled to a plurality of units.

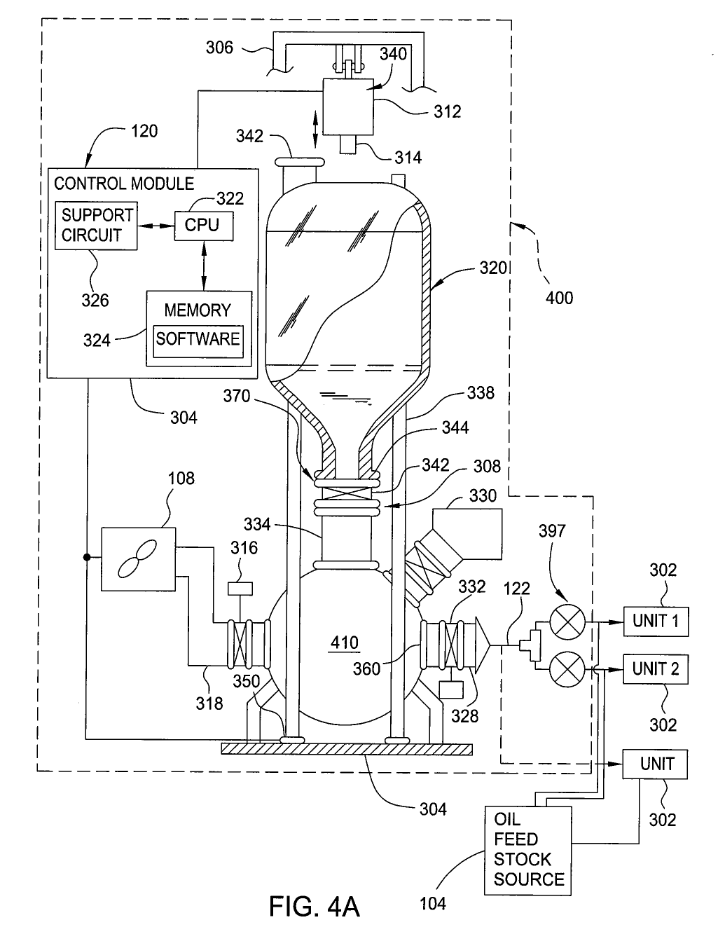

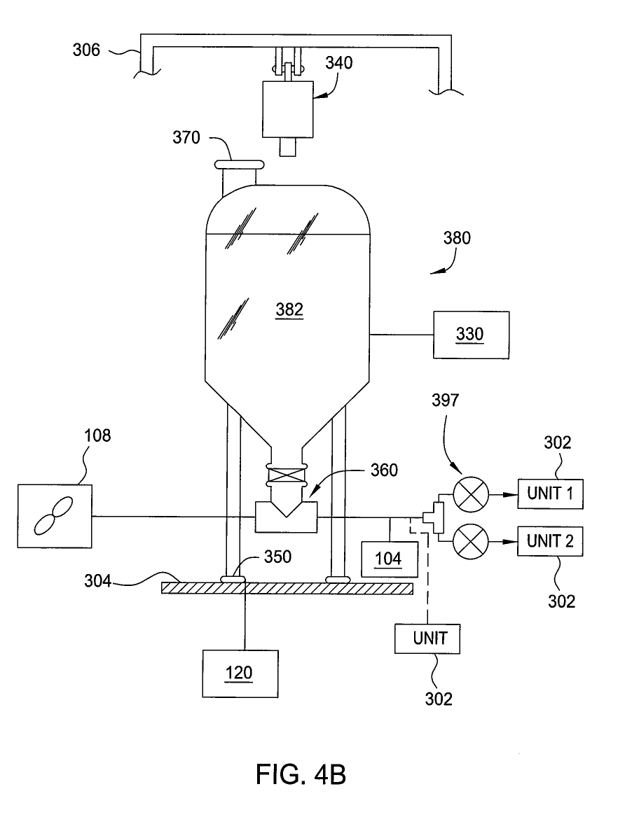

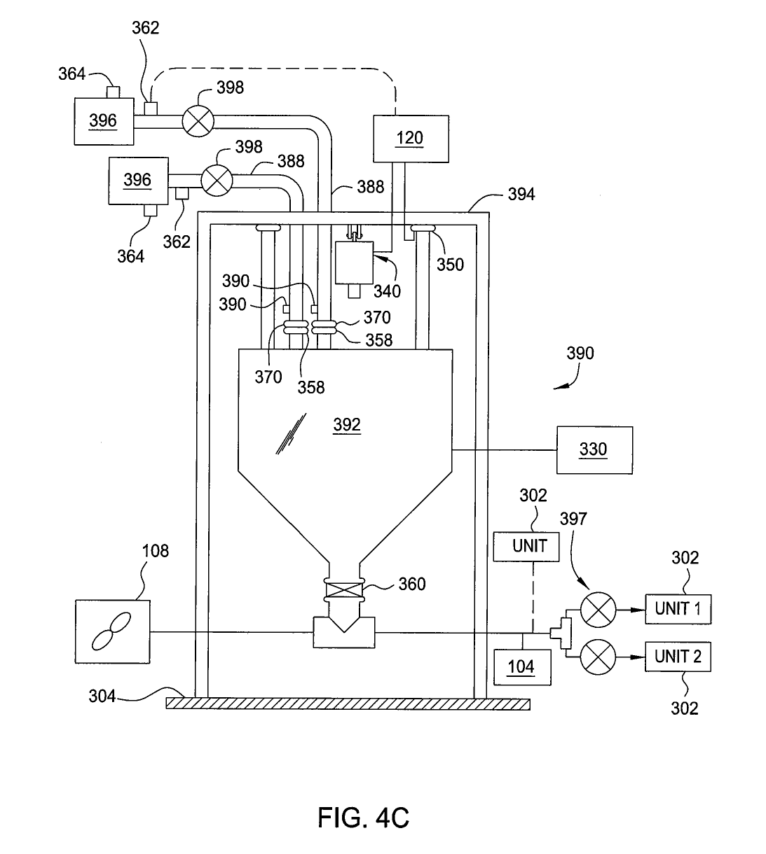

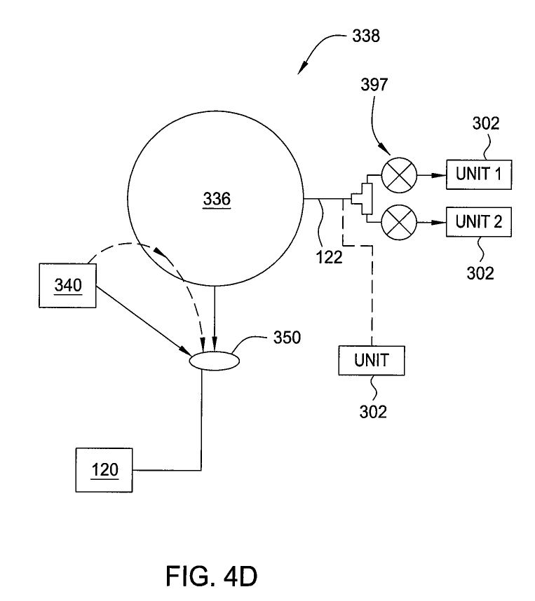

In one embodiment, one or more load cells 350 (as shown in at least in the embodiment depicted in FIG. 4A) are configured to provide a metric indicative of known force imparted on the load cell or delivery vessel.

In a particular embodiment depicted in FIG. 3A, one or more devices to minimize backflow 399 may be utilized in-line between the unit 302 and the dispense mechanism outlet 360 to minimize or prevent backflow from the unit 302 to the vessel 310 and or minimize or prevent backflow from one unit to another unit. In one embodiment, device to minimize backflow 399 includes a safety valve. A control module 120 may be interfaced with the safety valve 399 and associated dispense mechanism outlet 360 to control the operational states such that the safety valve 399 is only open if the pressure on the delivery vessel-side of the safety valve 399 is greater than the pressure on the unit-side of the safety valve 399. In another embodiment, device to minimize backflow 399 includes one or more simple mechanical check valve, also known as non-return valve. Non-limiting examples of simple mechanical check valves suitable for use include swing or flapper type. Incorporation of the device to minimize backflow 399 is optionally contemplated in all embodiments.

In one non-limiting embodiment, as shown in FIG. 3A, a plurality of dispense mechanisms outlets 360 are respectively coupled to a plurality of units 302 separately. In another non-limiting embodiment, as shown in FIG. 3B, the plurality of dispense mechanism outlets 360 of a delivery system 300B are respectively coupled to a plurality of units 302 separately, wherein at least one of the dispense mechanism outlets 360 may be coupled to a selected one of the units 302 by a selector or diverter valve 397. The selector valve may also be several shut off valves coupled by a T. The T is coupled to the outlet of the one or more dispense mechanisms. The outlets of the shut off valves are coupled to the plurality of units. In such an embodiment as FIG. 3B, one or more outlets 360 or pipings of the outlet which couples to the multiple units 302 are connected at least partially at one or more points. In another embodiment of a delivery system 300C, as shown in FIG. 3C, a plurality of dispense mechanism outlets 360 are respectively coupled to a unit 302 separately. In another embodiment of a delivery system 300D, as shown in FIG. 3D, a plurality of dispense mechanisms are respectively coupled to a unit 302.

The material delivery systems 300A-B suitable for delivering various materials and embodiments of the invention are not limited by what the material is being delivered or the form of the material being delivered. Examples of compositions of material include but are not limited to alumina, silica, zirconia, aluminosilicates, hydrotalcites such as described in Applicant's U.S. Pat. No. 6,028,023 and precursors to hydrotalcites such as described in Applicant's U.S. Pat. No. 7,347,929 etc., either individually or in a combination of two or more thereof. Non-limiting examples of the form of material include liquid, powder, formed solid shapes such as microspheres, beads, and extrudates, either individually or in a combination of two or more forms. Materials may be referred as and include catalyst, product, powder, additive, equilibrium spent catalyst, and catalyst fines. Non-limiting examples of material delivery systems 300 include a material addition vessel such as a pressurized vessel, a batching vessel for delivering as liquid, powders, and formed solid shapes such as microspheres, beads, and extrudes, either individually or in a combination of two or more, and storage vessels for liquid, powders, and formed solid shapes such as microspheres, beads, and extrudates, either individually or in a combination of two or more.

In an embodiment, the material delivery systems 300A-D are configured to deliver material to one or more units 302 such as, but not limited to, an FCC unit, fixed bed or moving bed unit, bubbling bed unit, units suitable for the manufacture of pyridine and its derivatives, units suitable for the manufacture of polypropylene, units suitable for the manufacture of polyethylene, units suitable for the manufacture of acrylonitrile, and other units suitable for industrial processes, etc., either individually or in a combination of two or more. In a particular embodiment, the material delivery systems 300A-D may be configured to deliver material to a plurality of units 302 that are FCC units. In such embodiment, the delivery vessel may have an operational pressure of about 0 to about 100 pounds per square inch. The FCC unit is adapted to promote catalytic cracking of petroleum feed stock provided from a source and may be configured in a conventional manner. One example of a material delivery system that may be adapted to benefit from the invention is described in U.S. Pat. No. 6,974,559, issued Dec. 13, 2005, which is incorporated by reference in its entirety. In one embodiment, the material delivery system 300A or 300B is configured to deliver material to the plurality of FCC units through the outlet or outlets of the 360 of the delivery vessel 310 that is coupled to the units 302. In another embodiment, the material delivery system is configured to deliver material to units designed to crack gasoline into Liquefied Petroleum Gas (LPG) such as but not limited to Superflex™ process or crack heavy feed into LPG instead of gasoline such as but not limited to Indmax™ process. In another particular embodiment, the material delivery system 300C or 300D may be configured to deliver material to a unit 302 for processing acrylonitrile. The delivery vessel 310 has at least outlet 360 adapted for coupling to unit 302. An example of a unit 302 suitable for the manufacture of acrylonitrile is a fluidized bed process. Similar units are also used for manufacturing other chemicals such as pyridine.

In such an embodiment, the delivery vessel has an operational pressure of about 5 to about 30 pounds per square inch.

In a particular embodiment illustrated in FIG. 4A, a material delivery system 400 may be supported on a surface 304, such as a concrete pad, metal structure or other suitable support. Although not completely shown, the frame 306 is supported by the surface 304. The frame 306 may be fabricated from any rigid materials suitable such that deflection of the frame 306 does not introduce error into the measurement by the load cell 350.

In the embodiment depicted in FIG. 4A, a material delivery system 400 may also include a separate material storage container and a pressure control device 330. The material delivery system 400 may be configured to be coupled to one or more units 302 as described with reference to FIGS. 3A-D, among other configurations. One or more storage containers 320 are interfaced with the load cell 350 such that changes in the weight of a storage container 320 may be utilized to determine the amount of material i.e. catalyst, product, powder, additive, etc., delivered to the one or more units 302 through the delivery vessel 310. The pressure control device 330 is coupled to the delivery vessel and configured to selectively pressurize the delivery vessel relative to the storage vessel to a pressure sufficiently high to provide material to the unit 302. It should be appreciated that the material delivery system can include one or more delivery vessels, one or more separate material storage containers, one or more pressure control devices, and one or more load cells and connected to one or more units 302.

FIG. 4B depicts another embodiment of a material delivery system 380 for delivering material to a unit 302. The material delivery system 380 may be configured to be coupled to one or more units 302 as described with reference to FIGS. 3A-D, among other configurations. The material delivery system 380 includes a pressure vessel 382 of a size suitable for storing enough material for a number of material additions performed over a selected interval, such as over a 24 hour period. The material delivery system 380 generally has a pressure control device 330, and at least one of load cell 350. The vessel 382 is loaded while at atmospheric or sub-atmospheric pressure though an inlet port 370. Once the vessel 382 is loaded, the inlet port 370 is closed and the vessel 382 is pressurized by the pressure control device 330 to a level that facilitates delivery of the material to the unit 302. In one embodiment, catalyst is metered to an FCC unit by selectively opening an outlet port 360 of the vessel 382. The load cells 350 are utilized to monitor the change in weight of the vessel 382 such that the amount of material delivered to the unit 302 through the outlet port 360 can be resolved. One example of a material delivery system that may be adapted to benefit from the invention is described in U.S. Pat. No. 7,050,944, issued May 23, 2006, which is incorporated by reference in its entirety.

FIG. 4C depicts another embodiment of a material delivery system 390 connected to more than one unit 302. The material delivery system 390 may be configured to be coupled to one or more units 302 as described with reference to FIGS. 3A-D, among other configurations. The material delivery system 390 includes a pressure vessel 392 shown suspended from a frame 394. Alternatively, the vessel 392 may be supported from the surface 304. The size of the vessel 392 may be selected to store enough material for a number of material additions performed over a selected interval, such as over a 24 hour period. Alternatively, the size of the vessel 392 may be selected to store only enough material for a single addition of material to the system, or for a limited number of additions performed over a selected interval. The material delivery system 394 generally has a pressure control device 330, and at least one of load cell 350. In one embodiment, the vessel 392 is loaded while at atmospheric or sub-atmospheric pressure through an inlet port 370 from one or more storage containers 396. In one embodiment, the vessel 392 is loaded at slightly positive pressure. In another embodiment, selection between storage containers 396 may be made using a manifold and/or control valves coupling the containers 396 to a common inlet port, or by selectively actuating a respective valve 398 disposed in series with a hose 388 individually coupling each container 396 to a respective inlet port 370. The inlet ports 370 may be fitted with self-sealing quick connects which prevent flow through the port 370 when the hose 388 is not connected. Alternatively, each port 370 may be fitted with a valve to control the flow therethrough. The containers 396 may be used to hold different or the same type of material. Although only two containers 396 are shown, it is contemplated that the material delivery system 390 may be configured to accept any number of containers 396. Once the vessel 392 is loaded, the inlet port 370 is closed and the vessel 392 is pressurized by the pressure control device 330 to a level that facilitates delivery of the material. Material is metered to the unit 302 by selectively opening an outlet port 360 of the vessel 392. In one embodiment, the load cells 350 are configured to monitor the change in weight of the vessel 392 such that the amount of material delivered to the unit 302 through the outlet port 360 can be resolved.

FIG. 4D is a high level schematic diagram of another embodiment of a material delivery system 338 suitable for providing material to more than one unit 302, such as an FCC unit. The material delivery system 338 may be configured to be coupled the unit 302 as described with reference to FIGS. 3C-D, among other configurations. The material delivery system 338 includes one or more material delivery vessels 336. At least one vessel 336 is interfaced with one or more load cells 350. The one or more load cells 350 are coupled to the vessel 336 in a manner that enables a control module 120 to resolve an amount of material passing through the system 338 to one or more units 302. In one embodiment, the one or more load cells 350 are utilized to determine a change in weight of at least one material delivery vessel 336 which is indicative of the amount of material provided by the material delivery system 338 to at one or more unit 302.

In a particular embodiment, the material delivery system further includes an automated weight calibration device 340. The automated weight calibration device 340 is adapted to impart a force of known value to the vessel 336 or a load cell of the material delivery vessel 336. The automated weight calibration device 340 is configured to generate a force upon the vessel 336. The force may be a push or pull. The automated weight calibration device 340 may be coupled to the vessel 336, or only contact the vessel 336 when actuated to generate the force. It is also contemplated that the automated weight calibration device 340 may be coupled to the vessel 336 and actuated to exert a force on the frame 306 or surface 304 (such as shown for example in FIG. 4C). The automated weight calibration device 340 may be a pneumatic or hydraulic cylinder, a motorized power or lead screw, a cam, linear actuator or other suitable force generation device. The amount of force generated by the automated weight calibration device 340 is generally selected to be in a range suitable for calibrating the load cells 350.

In the embodiment depicted in FIG. 4A, the automated weight calibration device 340 is a pneumatic cylinder 312 having a rod 314 that may be actuated to contact and press against the container 320. By precisely controlling the pressure of the air provided to the cylinder 312, the rod 314 will exert a predetermined force against the container 320 which can be utilized to confirm the accuracy and/or calibrate the load cell 350. Systems and methods of using calibration device are disclosed in U.S. application Ser. No. 11/923,136 which is incorporated by reference in entirety.

### Computer Control Unit

In one embodiment, the material delivery system is coupled to a plurality of units 302, such as a plurality of FCC units, and is configured to deliver one or more materials into the units to control processing attributes such as the ratio of products recovered in a distiller of the FCC unit and/or to control the emissions from the FCC unit. The material delivery system includes a control module 120 to control the rates and or amounts of material that the material delivery system provides to the FCC units 302.

Referring to FIG. 4A, the control module 120 has a central processing unit (CPU) 322, memory 324, and support circuits 326. The CPU 322 may be one of any form of computer processor that can be used in an industrial setting for controlling various chambers and subprocessors. The memory 324 is coupled to the CPU 322. The memory 324, or computer-readable medium, may be one or more of readily available memory such as random access memory (RAM), read only memory (ROM), floppy disk, hard disk, or any other form of digital storage, local or remote. The support circuits 326 are coupled to the CPU 322 for supporting the processor in a conventional manner. These circuits include cache, power supplies, clock circuits, input/output circuitry, subsystems, and the like. In one embodiment, the control module 120 is a programmable logic controller (PLC), such as those available from GE Fanuc. However, from the disclosure herein, those skilled in the art will realize that other control modules such as microcontrollers, microprocessors, programmable gate arrays, and application specific integrated circuits (ASICs) may be used to perform the controlling functions of the control module 120. Control module 120 that may be adapted to benefit from the invention is described in the U.S. Pat. No. 7,050,944 issued May 23, 2006; U.S. Pat. No. 6,859,759 issued Feb. 22, 2005; U.S. Pat. No. 7,369,959 issued May 6, 2008,; U.S. patent application Ser. No. 10/859,032 filed Jun. 2, 2004; and U.S. patent application Ser. No. 11/136,024 filed May 24, 2005, all of which are incorporated by reference in their entireties.

The procedure is generally stored in the memory of the control module 120, typically as a software routine. The software routine may also be stored and/or executed by a second CPU (not shown) that is remotely located from the hardware being controlled by the control module 120. Although the procedure or parts are discussed as being implemented as a software routine, some of the disclosed method steps may be performed in hardware as well as by the software controller, or manually. As such, the invention may be implemented in software as executed upon a computer system, in hardware as an application specific integrated circuit, or other type of hardware implementation, manually, or a combination of software, hardware, and/or manual steps.

In another embodiment, the control module 120 of the material delivery system includes, but is not limited to, one or more of the following components either individually or in a combination of two or more: Interface screen such as a standard or touch screen; Input device such as buttons, mouse, keyboard, touch screen, PLC or other control device; Connection between devices such as direct integration, interconnect cable, Ethernet network; Communication router/modem for connecting to a remote location via land line Telco line, internet or other wireless data network; MODBUS or other hardwire connection for connection to the control room or other central location of the plant where the unit is being used; Power supply for providing electrical power to the electrical devices; Solenoid valves, relays, etc. which are connected to either the PLC or central processing unit which are capable of modulating the position of the valves as well as read the input data from the various sensors and other devices connected to the unit; and or Antenna of communication of router/modem to internet or other wireless data network.

### Material Delivery System

Referring back to FIG. 4A, in one embodiment, the material delivery system 300 includes a material storage container 320 coupled to a metering device 308. The metering device 308 is coupled to the control module 120 so that an amount of material delivered to the unit or units 302 may be monitored and/or metered. In one embodiment, the material storage container 320 is a container adapted to store material therein at substantially atmospheric pressures and has an operational pressure of between about zero to about 30 pounds per square inch. The material storage container 320 has a fill port 342 and a discharge port 334. The discharge port 334 is connected to the inlet 370 of the deliver vessel 310 and is typically positioned at or near a bottom of the material storage container 320.

The metering device 308 is coupled to the discharge port 344 to control the amount of material transferred from the material storage container 320 to the delivery vessel 410 through a material delivery line or inlet 370. The metering device 308 may be a shut-off valve, rotary valve, mass flow controller, pressure vessel, flow sensor, positive displacement pump, or other device suitable for regulating the amount of material dispensed from the material storage container 320 into the delivery vessel 410 for injection into the unit 302. The metering device 308 may determine the amount of material supplied by weight, volume, time of dispense, or by other means. Depending on the material requirements of the unit 302, the metering device 308 may be configured or programmed to provide the desired amount of material or combination of materials. For example, when a unit 302 includes an FCC unit, the metering device 308 may be configured or programmed to provide such as from about 5 to about 4000 pounds per day of additive-type catalysts (process control catalyst) or from about 1 to about 20 tons per day of main catalyst. The metering device 308 typically delivers catalysts over the course of a planned production cycle, typically 24 hours, in multiple shots of predetermined amounts spaced over the production cycle. However, catalysts may also be added in an “as needed” basis or in a shot pot, as depicted in FIG. 4A. In another embodiment, when the unit 302 includes acrylonitrile processing unit, the metering device 308 may be configured or programmed to provide such as from about 30 to about 100 pounds per day of catalysts or may range as high as 5000 pounds per day of catalyst. In an embodiment, the metering device 308 is a control valve 332 that regulates the amount of material delivered from the catalyst storage container 320 to the unit 302 by a timed actuation. Control valves suitable for use as a metering device are available from InterCat Equipment Inc., located in Sea Girt, N.J.

In a particular embodiment, the delivery vessel 410 is rigidly coupled to the mounting surface 304, as load cells are not needed to determine the weight of the delivery vessel 410 in this embodiment. The term “rigidly” include mounting devices, such as vibration dampers and the like, but excludes mounting devices that “float” the pressure vessel to facilitate weight measurement thereof. When the delivery is vessel is designed to deliver the entire vessel content and a zero calibration check may be performed, the delivery vessel may be mounted or unmounted. In one embodiment, the delivery vessel 410 has an operational pressure of about 0 to about 100 pounds per square inch, and is coupled to a fluid source (e.g., a blower or compressor 108) by a first conduit 318. The first conduit 318 includes a shut-off valve 316 that selectively isolates the fluid source from the delivery vessel 410. A second conduit 328 couples the delivery vessel 410 to the unit 302 and includes a second shut-off valve 332 that selectively isolates the delivery vessel 410 substantially from the unit 302. The shut-off valves 316 and 332 are generally closed to allow the delivery vessel 410 to be filled with material from the material storage container 320 at substantially atmospheric pressure. In one embodiment, the controller or control module includes instructions, that when executed, prevent the pressure control valve and the discharge valve from simultaneously being in an open state.

Once the material is dispensed into the delivery vessel 410, the control valve 342 is closed and the interior of the delivery vessel 410 is pressurized by a pressure control device 330 to a level that facilitates injection of the material from the delivery vessel 410 into the unit 302, typically at least about 20 pounds per square inch. After the loaded delivery vessel 410 is pressurized by the pressure control device 330, the shut-off valves 316 and 332 are opened, allowing air or other fluid provided by the fluid source (e.g., blower 108) to enter the delivery vessel 410 through the first conduit 318 and carry the material out of the delivery vessel 410 through the second conduit 328 to the unit 302 through the process line 122. In one embodiment, the fluid source provides air at about 60 to about 100 psi (about 4.2 to about 7.0 kg/cm2).

In operation, the material delivery system 400 periodically dispenses a known quantity of material into one or more units 302. Material is filled into the low pressure material storage container 320 through the fill port 342 located in an upper portion of the material storage container 320. The weight of the storage vessel, including any material residing therein, is obtained by interpreting data obtained from the load cells 350.

In one embodiment, a predefined quantity of material in the catalyst storage container 320 is transferred into the delivery vessel 410 by selectively opening the control valve 342 for a defined amount of time. After the material has been transferred, the weight of the catalyst storage container 320 is obtained once again, and the exact quantity of delivered material is determined by subtracting the current weight from the previous measurement. Once the material is transferred to the delivery vessel 410, the pressure inside the delivery vessel 410 is elevated by the pressure control device 330 to, typically, at least about 20 psi. After operating pressure is reached, valves 316 and 332 are opened. This allows fluid supplied by the fluid source, typically air at approximately 60 psi, to flow through the delivery vessel 410 and carry the catalyst to the unit 302.

Advantages of the metering system include but are not limited to the following such as below. Bulk storage of the catalyst at high pressure is not required, thereby allowing the catalyst storage container 320 to be fabricated less expensively as compared to pressurized bulk storage containers of some conventional systems.

### Sensors

Sensors may provide one or more of the following information: In an embodiment depicted in FIG. 4C, sensors 362 are mounted proximate the inlet ports 370 such that a determination of whether or not a specific hose 388 is connected to the inlet port 370 of the pressure vessel 392. If a hose 388 is not connected to the port 370, the specific valves(s) associated with that particular port 370 can be automatically locked so that catalyst is not released from that port. This locking may be performed on manually or automated using the control module 120. The locking of a specific port permits safer operation of the delivery system 390 and prevents release of materials into the environment. Furthermore, by taking only a specific port off-line, the delivery system 390 may continue to safely operate and provide material to the unit 302 such that the unit 302 can continue to operate without interruption or down time, in an automatic mode of operation. Once the sensor 362 indicates re-connection to the container/bin, the availability of material from the container 396 associated with that hose 388 is recognized by the control module 120. In one embodiment, the valves are capable of withstanding repeated cycling with streams containing abrasive materials, such as but not limited to, ceramic powders, clay, aluminum oxide, silicon oxide, zeolite, phosphorus oxide, or other high temperature reaction products.

If additional safety is required, a light, horn or other notification device can be activated to notify the operator to switch from inactive to active for the specific port 370 using the computer control module 120.

In another embodiment, a sensor 362 may be affixed to the end of the hose 288 coupled to the container 396. The sensor 362 is configured to provide the control module 120 with a metric indicative of at least one of the presence of the container or material disposed in the container. In one embodiment, the sensor 362 detects information provided on an RF readable tag 364 coupled to the container 396. The RF readable tag 364 may contain information relating to the unique identification of the container 396, such that the control module 120 may obtain information relating to the material inside that container 396. In another embodiment, the tag 364 may include information relating to the material inside container 396. Thus, utilizing the sensor 362, the control module 120 can confirm that a container 396 containing the correct material was coupled to the hose 388, thereby insuring that the correct material is injected into the unit 302 while minimizing the potential for operator error. It is contemplated that information from the sensors 362 and 362 may be utilized to lock the associated port 370 as described above. In another embodiment, the sensor 362 detects information provided on a bar code coupled to the container 396. In yet another embodiment, the sensor 362 detects information provided on an RF readable tag 364 and or bar code coupled to the container 396

Referring to FIG. 4A, the material delivery 400 may also include one or more sensors for providing a metric suitable for determining the amount of material passing through the metering device 308 during each transfer of material to the vessel 410. Alternatively, the sensors may be configured to detect the level (i.e., volume) of material in the material storage container 320, the weight of material in the material storage container 320, the rate of material movement through the material storage container 320, discharge port 344, metering device 308, and/or material delivery line 334 coupling the container 320 and vessel 410, or the like.

In an embodiment, the sensor includes a plurality of load cells 350 adapted to provide a metric indicative of the weight of material in the material storage container 320. The load cells 350 are respectively coupled to a plurality of legs 348 that support the material storage container 320 above a mounting surface 304. Each of the legs 348 has one of the plurality of load cells 350 coupled thereto. From sequential data samples obtained from the load cells 350, the control module 120 may resolve the net amount of transferred material after each actuation of the metering device 308 (e.g., the control valve 342). Additionally, the cumulative amount of material dispensed over the course of the production cycle may be monitored so that variations in the amount of material dispensed in each individual cycle may be compensated for by adjusting the delivery attributes of the metering device 308, for example, by changing the open time of the control valve 342 to allow more (or less) material to pass there through and into the delivery vessel 410 for ultimate injection into the unit 302.

In another embodiment, the sensor may be a level sensor (not shown) coupled to the material storage container 320 and adapted to detect a metric indicative of the level of material within the material storage container 320. The level sensor may be an optical transducer, a capacitance device, a sonic transducer or other device suitable for providing information from which the level or volume of material disposed in the material storage container 320 may be resolved. By utilizing sensed differences in the levels of material disposed within the material storage container 320 between dispenses, the amount of material delivered may be resolved for a known storage vessel geometry.

In yet another embodiment, the sensor may be a flow sensor (not shown) adapted to detect the flow of material through one of the components of the material delivery system described herein. In one embodiment, the flow sensor may be a contact or non-contact device and may be mounted to the material storage container 320 or the material delivery line 334 coupling the material storage container 320 to the delivery vessel 410. For example, the flow sensor may be a sonic flow meter or capacitance device adapted to detect the rate of entrained material (i.e., catalyst) moving through the material delivery line 334.

### Plurality of Separate Material Storage Containers Coupled to the Vessel

Although the material delivery system 400 described in FIG. 4A is shown configured to provide material from a single low pressure material storage container 320, the invention contemplates utilizing one or more material delivery systems coupled to one or more units 302 to introduce multiple materials from a plurality of separate material storage containers. Each of these material storage containers may be controlled by either common or independent control modules 120.

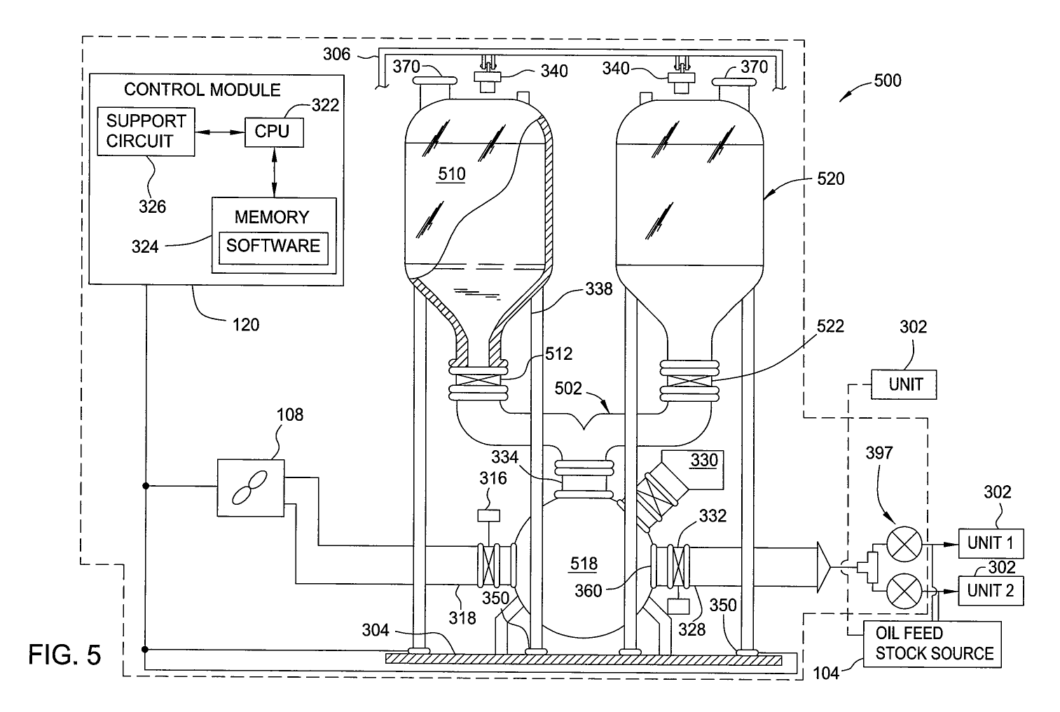

FIG. 5 depicts another embodiment of a material delivery system 500 adapted to provide multiple materials to one or more units 302, such as an FCC unit. The material delivery system 500 may be configured to be coupled the unit 302 as described with reference to FIGS. 3C-D, among other configurations. The material delivery system 500 includes a delivery vessel 518 coupled to a plurality of separate material storage containers (i.e. storage vessels or low pressure vessels), illustratively shown in one embodiment as a first low pressure material storage container 510 and a second low pressure storage container 520. Any number of low pressure material storage containers may be coupled to a single delivery vessel 518, based on need and desire of the number of materials or time limit of material delivery, etc.

The separate material storage containers 510, 520 may be configured to deliver the same or different materials to the unit(s) 302 and operate substantially similar to material storage container 320, described above with reference to FIG. 4A. In one embodiment, the storage vessels i.e. low pressure material storage container 510, 520 are coupled to a manifold 402 which directs the plurality of materials to a common material delivery line 334 for delivery into the delivery vessel 518. Alternately, each material storage container 510, 520 can be independently coupled to the delivery vessel 518 via a respective inlets formed in the vessel 310. Each material storage container 510, 520 is coupled to an independent metering device 512, 522 which controls the amount of material delivered from each material storage container 510, 520 to the delivery vessel 518 for injection into the unit 302. In one embodiment, the metering device 512, 522 is configured similar to the metering device 308 described above. Furthermore, in one embodiment, one least one load cell 350 is configured to provide a metric indicative of an amount of material dispensed from each separate material storage container 510, 520.

In this configuration, the material delivery system is capable of sequentially providing material from a predefined one of the material storage container storage container 510, 520, or alternatively, blending measured amounts from each material storage container storage container 510, 520 in the delivery vessel 518 for injecting into one or more units 302 in a single shot pot delivery or series of injections. The material delivery system 500 may further include one or more sensors to determine if the delivery vessel is respectively coupled to the inlet of a material storage container from the plurality of separate material storage containers.

At Least Tow Compartments within Vessels

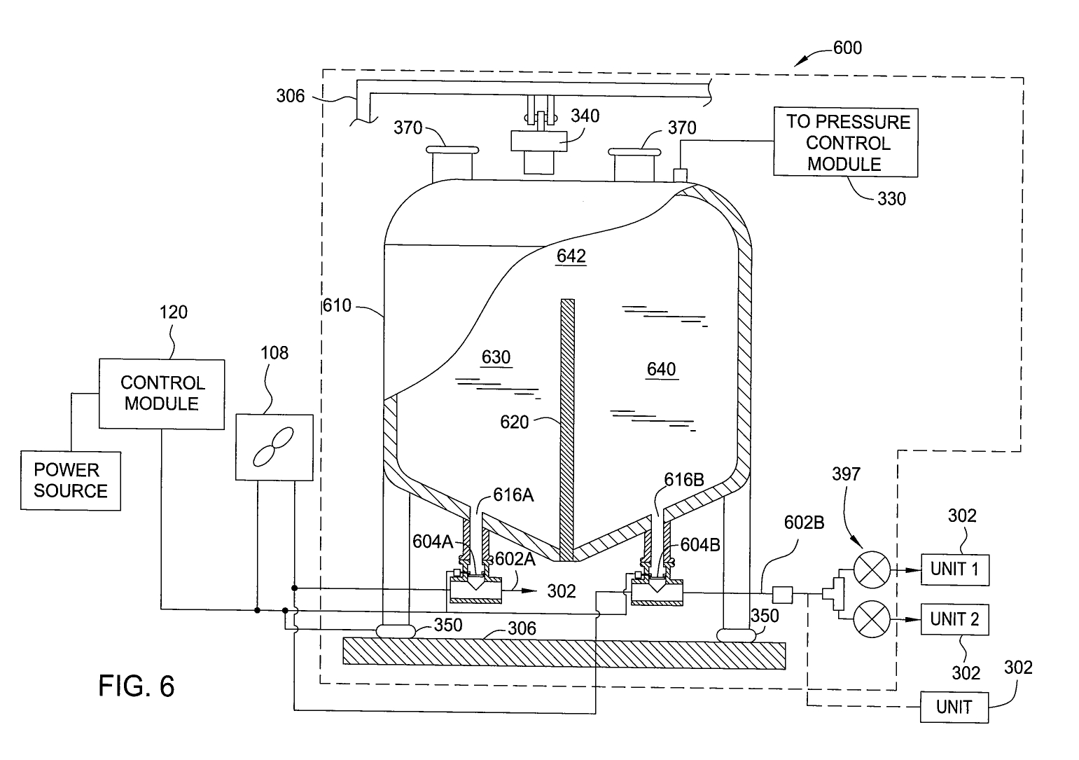

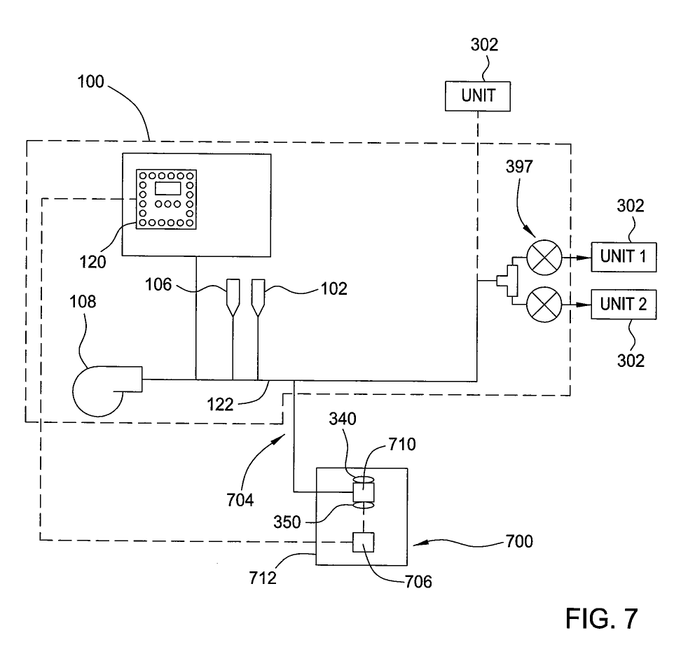

FIG. 6 depicts another embodiment of a material delivery system 600 coupled to one or more units 302, such as an FCC unit. The material delivery system 600 may be configured to be coupled the unit 302 as described with reference to FIGS. 3C-D, among other configurations. The material delivery system 600 is adapted to provide multiple materials to the unit(s) 302, either in a mixed state or individually. The material delivery system includes a delivery vessel 610 interfaced with one or more load cells 350 suitable for providing a metric suitable for resolving a change in weight of the vessel 610.

The vessel 610 also includes a separator 620 disposed in the vessel and defining at least two compartments 630, 640 within the vessel. A plenum 642 may be defined in the vessel common to each compartments, or each compartment may have its own separate plenum above the material disposed therein. Each compartment 630, 640 has a respective outlet 616A, 616B. It is contemplated that the vessel may be divided into any number of compartments and each compartment may independently be of varying shape.

The compartments 630, 640 may be configured to deliver the same or different materials to one or more units 302 and operate substantially similar to material delivery systems described above. In one embodiment, the outlets 616A, 616B of the delivery vessel are coupled by delivery lines 602A, 602B to a manifold, the outlet of which directs the plurality of materials to a single unit 302. Alternately, each outlet 616A, 616B of the delivery vessel can be independently coupled via a respective delivery lines 602A, 602B to two or more separate units 302. Each compartment may be coupled to an independent metering device 604A, 604B which controls the amount of material delivered from each compartment of the delivery vessel 610 for injection into the unit 302. In one embodiment, the metering devices 604A, 604B are configured similar to the metering devices described above.

In an embodiment, the material delivery system 600 is capable of sequentially providing material from a defined compartment of the delivery vessels to one or more units. The material delivery system may further include one or more sensors to determine if the unit is respectively coupled to the correct compartment from the plurality of compartments of the vessel.

In a particular embodiment, the material delivery system includes a control module 120 for controlling the rates and/or amounts of material provided to one or more units 302 by the material delivery system 500.

### Mobile Material Delivery System

FIG. 7 is a simplified schematic of an embodiment of a material delivery system 700 which is mobile. In an embodiment, the mobile material delivery system 700 may be configured to be coupled the unit 302 as described with reference to FIGS. 3C-D, among other configurations. The mobile material delivery system 700 is configured to be easily transportable over great distances thereby enabling the mobile material delivery system 700 to be shipped and coupled to one or more existing units 302, such as but not limited to a FCC unit on short notice. Additionally, the modular aspects of the mobile material delivery system 700 also enables the material delivery system 700 to be decoupled from one unit 302, transported, and coupled to another unit 302 with minimal effort. Thus, the mobile material delivery system 700 enables a refiner to configure a working refinery with material delivery systems with minimal lead time, thereby providing the process control flexibility required to quickly take advantage of market opportunities and address unplanned events requiring process change, such as limiting emissions through catalyst reactions. In another embodiment, the modular aspects of the mobile material delivery system 700 enables the material delivery system 700 to be decoupled from one acrylonitrile process unit, transported, and coupled to another acrylonitrile process unit with minimal effort.

The mobile material delivery system 700 includes a material delivery vessel 710 mounted to a transportable platform 712. The vessel 710 may be configured similar to the other vessels described herein. The vessel 710 is interface with one or more load cells 350 that are configured to provide a metric suitable for determining an amount of material dispensed from the vessel 710 from a change in weight of the vessel 710. In an embodiment, the vessel 710 (and/or load cells 350) is interfaced with a calibration device 340 as described above.

The material delivery vessel 710 may be one or more vessel, or vessel and container combinations as described herein, among other suitable configurations. The vessel 710 is coupled by a conduit 704 to the process line 122 to deliver material to the unit 302. The conduit 704 may be a flexible process pipe, a temporary process pipe, or a hard pipe.

The transportable platform 712 is generally configured to support the material delivery vessel 710 and associated components. The transportable platform 712 may be mounted to a foundation of a unit 302, or be disposed adjacent thereto. The transportable platform 712 is configured to facilitate shipment of the mobile material delivery system 700 by conventional means, e.g., road, air, sea or rail. For example, in an embodiment, the mobile material delivery system 700 has a transportable platform 712 in the form of a container, which allows for rapid delivery of the mobile material delivery system 700 by conventional means, for example, by truck, ship, plane, train, helicopter, barge and the like. It is also contemplated the transfer platform 712 may be integrally part of a trailer, barge, ship, plane, truck, rail car and the like. The ease of transporting the platform 712 advantageously allows the mobile material delivery system 700 to be coupled and begin injecting material to a unit 302 within a matter of hours or even as little as less than one hour, compared with the several days required to install a conventional permanent or semi-permanent injection system, which is substantially less than the time required to ship, assembly and install a conventional injection system.

An embodiment of the mobile material delivery system 700 includes a vessel 710 that may be feed by a plurality of material storage containers, as described with reference to FIGS. 4C and 5. In another embodiment, the vessel 710 may have a plurality of internal compartments, as described with reference to FIG. 6 which may provide mixtures of different material as needed or per a predefined process sequence. Another embodiment of the mobile material delivery system 700 also provides mixtures of different material as needed or per a predefined process sequence.

### Methods

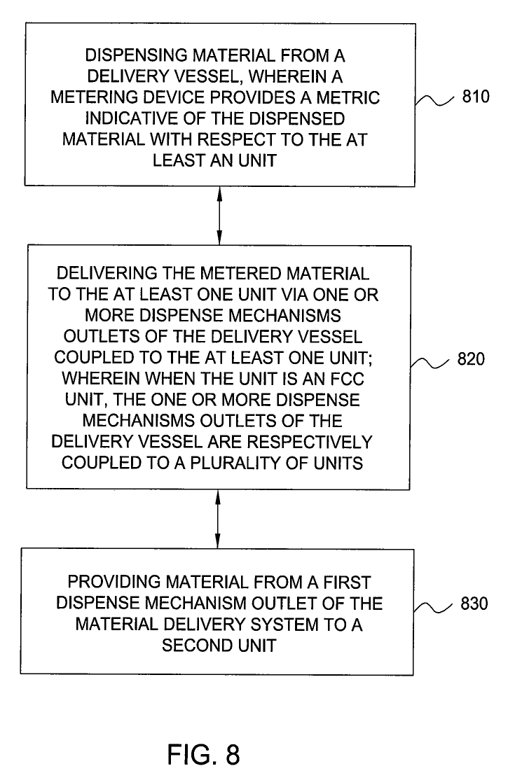

The invention also encompasses a method of delivering a material i.e. catalyst, additive, equilibrium spent catalyst, catalyst fines, etc. FIG. 8 is a flow diagram of one embodiment of a method 800 for delivering a material to at least one unit, with the proviso that when the unit is an FCC unit, the one or more dispense mechanisms outlets of the delivery vessel are coupled to a plurality of units. The method 800 may be practiced with the material delivery system described above, or other suitable delivery system. The method includes Step 810 dispensing material from a delivery vessel, wherein a metering device provides a metric indicative of the dispensed material with respect to the at least a unit.

The metric of the material includes but is not limited to a metric such as the amount of material, detect the rate of material moving through a conduit of know area, volume of material, and weight of material in the material storage containers, compartment of vessel of the delivery system, either individually or a combination of two or more thereof. In one embodiment, the determination may be made by metric such as but not limited to weight. Examples of weight determination include based on a ‘gain-in-weight’ and or ‘loss-in-weight’ by the vessel over the course of the material delivery. Step 810 may be repeated as many times as desired.

Step 820 includes delivering the metered material to the at least one unit via one or more dispense mechanisms outlets of the delivery vessel coupled to the at least one unit; with the proviso when the unit is an FCC unit, the one or more dispense mechanisms outlets of the delivery vessel are coupled to a plurality of units.

Steps 830 and/or 840 of the method 800 are optional and may be practiced in sequentially, simultaneously or in the alternative. At step 830, material from a second dispense mechanism outlet of the material delivery system may be provided to a second unit 302.

The material exiting the first and second dispense mechanism outlets may be of the same or different type of material. Switching of the connection of the first dispense mechanism outlet from the first unit to the second unit may be accomplished in a number of suitable manners, for example, by changing the state of a selector or diverter valve 397. For example, at step 840, material from the second dispense mechanism outlet of the delivery system may be provided to the first unit 302. Switching of the connection of the second dispense mechanism outlet from the second unit to the first unit may be accomplished as described above.

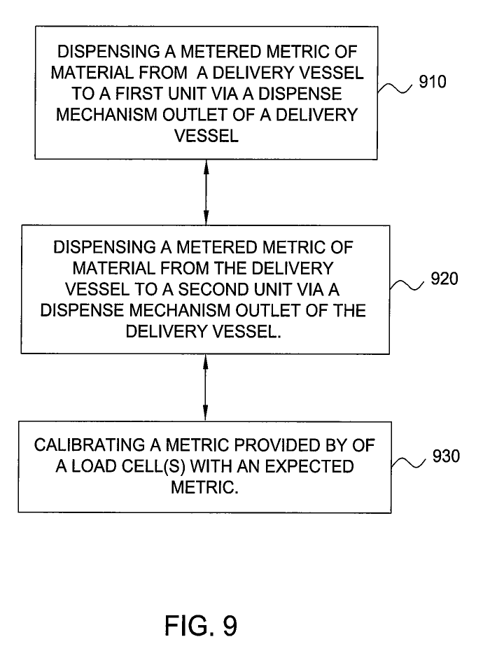

With reference to FIG. 9, next is described an embodiment of a method of providing a material to a plurality of units. Step 910 dispensing a metered metric of material from a delivery vessel to a first unit via a dispense mechanism outlet of a delivery vessel. Step 920 includes dispensing a metered metric of material from the delivery vessel to a second unit via a dispense mechanism outlet of the delivery vessel.

The methods described are not limited by a sequence of when and how a one or more materials are provided to the one or more units 302. Nor are the methods limited by the sequential order of steps or frequency of the delivery of the material or materials, such as wherein a plurality of materials may be simultaneously or sequentially.

The methods described allow delivery of multiple materials into one or more units 302 as needed, simultaneously or sequentially. For example, in one embodiment, the materials may differ from each other such as wherein one material may control emissions from the cracking process and another material may control the resultant cracked product mix produced by the FCC unit. The multiple materials which may or may not differ from each other may be delivered to the same unit or plurality of units 302. Controlling the delivery of multiple materials allows greater process flexibility with reduced capital expenditures.

Furthermore, the methods may include one or more of the following optional steps. In one embodiment, the method includes step 930 of calibrating a metric provided by of a load cell(s) with an expected metric. The optional step may include automated weight calibrating by imparting a known force to a delivery vessel coupled to at least a load cell and determining if the at least one load cell accurately detects the known force imparted on the vessel. For example, a step may be added to the methods described to include calibrating or comparing a metric provided by of a load cell(s) with an expected metric of the known force. For example, refinery processes may continue without interruption while the load cells of a material delivery system coupled to one or more units are calibrated in between addition(s) of material(s) without having to shut down the material delivery system, thereby maintaining a material delivery system in an operational state and ready to deliver material to one or more units as soon as the calibration step has been completed.

If the difference between the compared metric is outside of a predetermined range, a service flag may be issued. If the difference is within operational tolerances, then the software adjusts at least one of the output of the load cell or the software algorithm so that the output reading of the load cells is indicative of the true force upon the load cell, and consequently, a more accurate determination of the transfer material may be made. The method may also include recording the metric of the known force imparted on the vessel and determining any deviation between the recorded measured metric and known value.

The automated calibrating may be conducted a plurality of times at desired frequency intervals and as many times based on the degree of accuracy and precision need or wanted for an industrial system and acceptable deviation ranges that are allowed for a given weight of material to be delivered. The automated weight calibrating can periodically apply an equivalent weight to the delivery vessel and determine any deviation while continuing to deliver catalyst. In another embodiment, the automated weight calibrating may impart an equivalent weight to the delivery vessel and monitor any deviation regular on periodic basis, such as per dose, per hour, per day, per week, etc. In another embodiment, method includes automated weight calibrating each delivery of a material to an industrial process to check for accuracy of the amount of catalyst delivered.

Corrective action with respect to any deviation between the measured metric and known metric of the amount of material may also be performed. Corrective actions include, but are not limited to, adjusting any deviation between the measured weight and known metric of the material in proportion to the ratio of the deviation between the measured weight and known metric of the material, adjusting the load cell downward to equal the known value of the force imparted on the vessel, adjusting the load cell upward to equal the known metric of the material, adjusting at least a subsequent delivery of a material into one or more units 302 based on the deviation. Corrective action may also include introducing, during a subsequent basic cycle time, an amount of the material which is less than the nominal addition amount when the measured weight is less than the known metric of the material or introducing, during a subsequent basic cycle time, an amount of the material which is more than the nominal addition amount when the measured weight is greater than the known value of force imparted.

The methods above may further include one or more of the following optional step of integrating with an off-site computer database system. The information concerning any deviation between the measured metric and the known metric of the material may be sent to a remote control center outside of an FCC unit. For example, communication may be established between a control module of the material delivery system and a remote device in response to an event. Non-limiting examples of ‘remote device’ include such as but not limited to, a server or any computer terminal that interacts with the system via the Internet, a computer terminal located or accessed by a catalyst supplier or the production facility's inventory controller/planner, a lap top computer or PDA that is brought within communication range, etc.

The computer controller of the embodiments of the invention can be linked via land-line Telco, wireless modem, internet connection, etc. to a central server which can maintain the various parameters of the embodiments of the disclosed addition system. The notifications of injection of materials, deviations in measurement of known weight, etc. can either be made by the addition system itself, or via an externally connected computer system. Furthermore, the offsite external system can permit parameters within the addition system controller to be changed without a person physically being required to be on-site at the controller unit.

Another option is tracking of injected material i.e. product can also be accomplished with the embodiments of the disclosed addition system by sending data about a specific catalyst, date, time, amount of addition, back to the central database which further integrates with the previous usage of the catalyst as well as shipments to the specific location. From this inventory reconciliation, features such payment upon-delivery can be accomplished as well as notification to reorder upon reaching a minimum quantity threshold for a specific location/unit. Data can be removed from the disclosed embodiments of the invention systems via a variety of means. Data can be physically extracted via on-board USB or other type of memory storage device. Alternatively, data can be sent via electronic means over the internet or via a secure data network within the refinery or externally via land-line Telco line, wireless cellular network, etc. When data is sent via wireless cellular over the internet or other insecure means, then a virtual private network (VPN) may be employed. VPN technology, either hardware or software based, helps secure data transfers or communication between the addition system controller and the home network.

An embodiment includes a system for providing one or more material into one or more units. The system includes: a material delivery system for providing material to one or more units; an enclosure suitable for hazardous service; a controller disposed in the enclosure for controlling the additions made by the material delivery system; and a communication port coupled to the controller for communicating information regarding activity of the material delivery system to a device remote from the enclosure while the enclosure is sealed.

Another embodiment includes a system for providing one or more materials into one or more units. The system includes a storage vessel; a metering device coupled to the storage vessel and having an output adapted for coupling to the one or more units; one or more sensor for providing a metric indicative of the amount of material dispensed into the metering device; an enclosure suitable for hazardous service; a controller disposed in the enclosure and having a memory device for storing catalyst injection information derived from the metric provided by the sensor; and a communication port coupled to the controller for communicating information stored in the memory device to a remote device while the enclosure is sealed.

Yet another embodiment includes a method for providing one or more materials into one or more units. The method includes: dispensing material for a material delivery system into one or more units; storing a record of system activity indicative of the amount of material in a memory device disposed in an enclosure suitable of hazardous duty; and accessing the stored record from the enclosure while the enclosure remains sealed.

Another embodiment includes a material delivery system for metering material to a plurality of units. The material delivery system includes: an enclosure suitable for hazardous locations; a low pressure storage vessel; a pressure vessel having an outlet adapted to be coupled to the plurality of units and an inlet coupled to the low pressure storage vessel; at least one sensor adapted to provide a metric indicative of material transferred from the low pressure storage vessel to the pressure vessel; and a controller disposed in the enclosure for controlling material transferred from the pressure vessel to the plurality of units, wherein the controller configured for communicating information regarding activity of the apparatus to a device remote from the enclosure while the enclosure is sealed.

Another embodiment includes a material delivery system for metering material to one or more units. The material delivery system includes a low pressure storage vessel; a pressure vessel rigidly coupled to a supporting surface having an outlet adapted to be coupled to the one or more units and an inlet; a pressure control device coupled to the pressure vessel and configured to selectively pressurize the pressure vessel relative to the low pressure storage vessel; a metering device coupling the storage vessel to the in let of the pressure vessel; an enclosure suitable for hazardous service; a controller disposed in the enclosure for controlling injections made from the low pressure storage vessel; and a communication port coupled to the controller for communicating information regarding activity of the apparatus to a device remote from the enclosure while the enclosure is sealed.

Another embodiment includes material delivery system for metering material to one or more units. The material delivery system includes: a storage vessel; a metering device coupled to the storage vessel and having an output adapted for coupling to the one or more units; at least one sensor for providing a metric indicative of the amount of material dispensed through the metering device; an enclosure suitable for hazardous service; a controller disposed in the enclosure and having a memory device for storing catalyst injection information derived from the metric provided by the sensor; and a communication port coupled to the controller for communicating information stored in the memory device to a remote device while the enclosure is sealed.

Another embodiment includes a method for monitoring a material delivery system. The method includes one or more of the following steps: determining an occurrence of a predefined event associated with the material delivery system; establishing communication between a control module of the material delivery system and a remote device in response to the event, wherein the remote device is remote from the material delivery system; and wherein the step of establishing communication comprises transmitting information to the remote device in response to a predefined event; and information comprises automatically submitting a reorder request for material if a material inventory level is below a predefined threshold; and transmitting information relating to the event between the remote device and control module.

Another embodiment includes a method for monitoring a material delivery system. The method includes one or more of the following steps: storing data from the material delivery system in a memory device of a control module; establishing communication between the control module and at least one of a remote or a local device in response to a predefined protocol, wherein the predefined protocol further comprises an event sensed by at least one of the material delivery system or the control module and wherein the predefined protocol comprises an event which exceeds a threshold; and transmitting data from the memory device of the control module to the at least one of the remote or the local device.

Another embodiment includes a method for monitoring material requirements of a material delivery system. The method includes one or more of the following steps: automatically updating a material available inventory information of a plant in a digital memory device in response to a predetermined event; and automatically determining a sufficiency of the material available inventory of the plant. Method may further optionally include taking a re-supply action in response to a determination of insufficient material available inventory of the plant.

Another embodiment includes a method for monitoring material requirements of a material system. The method includes one or more of the following steps: dispensing material from the material delivery system; automatically updating material available inventory information of a plant in a digital memory device in response to the dispensing step; and automatically determining a sufficiency of the material available inventory of the plant. The method may further optionally include taking a re-supply action in response to a determination of insufficient catalyst available inventory of the plant.

Another embodiment includes a method for monitoring catalyst requirements of a material delivery system. The method includes one or more of the following steps: dispensing material from the material delivery system; automatically updating a material available inventory information of a plant in a first digital memory device of the material delivery system in response to the dispensing step; transferring the material available inventory information of the plant from the first digital memory device to a second digital memory device accessible from a control room of the site at which the material delivery system is located; and automatically determining a sufficiency of the material available inventory of the plant. The method may further optionally include taking a re-supply action in response to a determination of insufficient catalyst available inventory of the refinery.

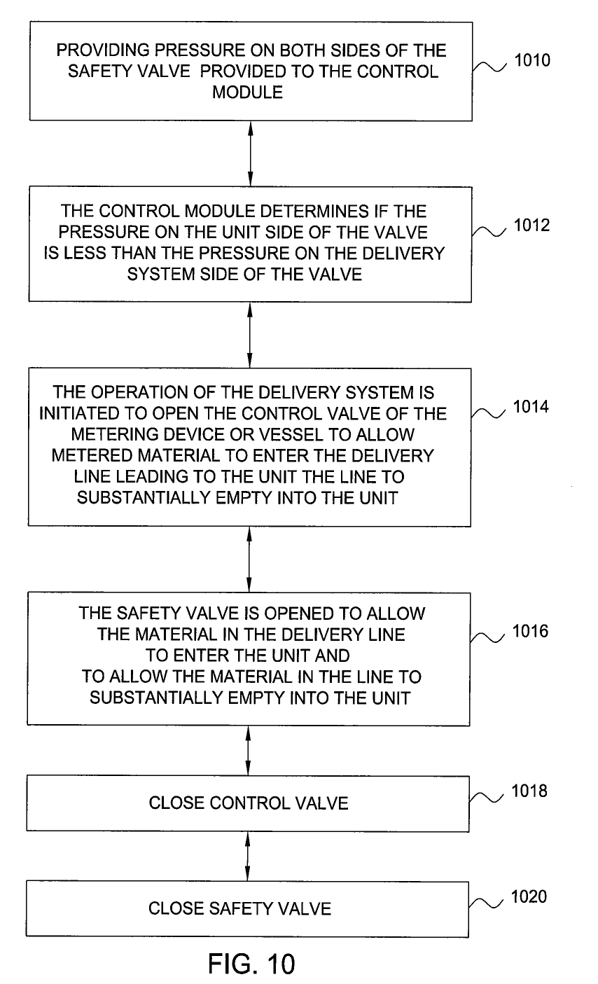

With reference to FIG. 10, next is described method of providing material to a unit in a manner that prevents backflow of material from one or more units to a delivery system, wherein the device to minimize backflow 399 is a safety valve. The method 1000 includes step 1010 wherein pressure on both sides of the safety valve 399 is provided to the control module 120. At step 1012, the control module 120 determines if the pressure on the unit side of the safety valve 399 is less than the pressure on the delivery system side of the safety valve 399. If the pressure on the unit side of the valve 399 is less than the pressure on the delivery system side of the safety valve 399, the method proceeds to step 1014. If the pressure on the delivery system side of the safety valve 399 is less than the pressure on the unit system side of the safety valve 399, the method proceeds to step 1016 wherein remedial action is taken. Remedial action may include at least one of locking out (stopping or preventing) the operation of the delivery system, actuating an alarm or flag, or notifying a predefined person via an electronic message, among other suitable actions. In one embodiment, remedial action includes preventing the safety valve 399 from changing to an open state.

At step 1014, the operation of the delivery system is initiated to open the control valve of the metering device or vessel to allow metered material to enter the delivery line leading to the unit 302. At step 1016, the safety valve 399 is opened to allow the material in the delivery line provided at step 1014 to enter the unit 302.

At step 1018, the control valve is closed. At step 1020, the safety valve 399 is closed. There may be a predefined delay between steps 1018 and 1020 to allow the material in the line to substantially empty into the unit 320.

Throughout the method 900, steps 1010 and 1012 are repeated to monitor if the safety valve 399 should be changed to and/or remain in a closed state.

### THE FOLLOWING EXAMPLES ARE FOR ILLUSTRATION AND NOT LIMITATION

### Example 1

### General Operation

A material delivery vessel is fitted with load cells and placed within a portable platform, such as a tubular frame structure. The portable platform does not require a foundation, unlike many other systems of similar daily throughput capacity. An example of such as configuration is provided with reference to FIG. 7. The delivery vessel includes multiple inlet ports for filling the vessel from separate containers, and a one or more discharge ports. Within this embodiment delivery vessel, there are no partitions. An example of such a configuration is provided with reference to FIG. 4C. However, other embodiments of a delivery vessel with partitions or parts are included within the scope of the invention, such as provided with reference to FIG. 6. The delivery vessel may include a plurality of inlet ports connected to two or more units, but the actual number of inlet ports may readily be increased or decreased, depending on preference of the number of different materials to be delivered or the number of units to which material (or materials) is to be delivered. The inlet ports of a delivery vessel are coupled to one or more material storage container which hold products, such as but not limited to fresh catalyst, additives, ECAT, and FCC fines, either individually or in a combination of two or more thereof.

As previously described, material includes catalyst, additive, equilibrium spent catalyst, catalyst fines, etc. and may be used interchangeably; embodiments of the material delivery system include providing a material regardless of the form of the material or what the material is referred as.

The total daily throughput to a particular unit depends on the number of inlet ports being used to deliver material to the particular unit, and the quantity of being added from each inlet. For example, in one embodiment, the delivery vessel is capable of adding in excess of 40-50 Metric tons (MT)/day of total material such as catalyst, etc. to one or more units 302. The amount of one or more respective materials delivered to one or more unit may range from a minimum value as low as a single delivery to as high as the maximum capacity of the delivery vessel, if no other materials are being delivered and no other units are connected to the delivery vessel. There is virtually an infinite number of combinations of the type of materials and the respective quantities of a given material which can be delivered to one or more units, either individually or in a combination of two or more materials to two or more units thereof.

In some embodiments, each inlet port, at its respective end-point, is connected to a material storage container. Non-limiting examples of types of material storage containers include but are not limited to, bulk bin, drum with port connector, portable bulk storage such as bulk storage totes (portable drytainer, wheeled PD truck, etc., and permanent bulk storage such as silo or other vessel that is located on-site.

The type of delivery vessel, along with the daily addition requirements of each material, and the number of units to which the delivery vessel is connected determines the frequency of change-out of containers or re-filling of the delivery vessels.

### Example 2

### Installation of the Delivers Vessel and Basic Components

The delivery vessel is connected to the input port connections via hard-pipe or flexible hosing using the provided fittings. In one embodiment, the delivery vessel has a configuration that provides 2 outlet fittings on each side of the delivery vessel which can be coupled to the one or more units.

In one embodiment, a sensor is disposed near the container of the delivery system to provide information such as but not limited to the name or type of catalyst, quantity of catalyst within the container or container identification code. Ultimately, the catalyst within each container is identified for each respective input port. The control module 120 keeps track of which materials are coupled to each of the inlet ports as well as keeping a running total of the quantity of each material that a delivery vessel delivers to a respective unit. Hence, a delivery vessel can be connected to multiple units while keeping track of the type and amount of material and materials delivered to the one or more units.

In one embodiment, each outlet port of the delivery vessel is connected via hard or flexible piping to an input port of a respective unit, where catalyst is normally injected.

A compressed gas supply is hooked up to the material delivery system. The compressed gas supply can be from sources such as fixed supply of the plant, portable unit, either individually or in combination of two or more thereof. In one embodiment, the compressed gas supply is of constant pressure and volume and contains minimum to substantially no water content. Examples of compressed gas supply includes such as but not limited to air supply, nitrogen, and inert gas either individually or in combination of two or more thereof.

Electrical connections are made to the main control unit, which powers the control module of the material delivery system, as well as the various valves and other electrical items within the material delivery system.

In one embodiment, the material delivery system contains its own frame to support the delivery vessel; hence, foundation is not required for this embodiment of the material delivery system.

### Example 3

### Operation of the System

The control module evaluates the material and materials that require delivery to each respective unit based on one or more combinations of the following non-limiting non-exclusive factors:
a. Number of materials being added
b. Type of material being added (catalyst or additive, fine, etc.)
c. Required addition rate of each material
d. Any off-line time during the recent past. This is required to possibly make-up any downtime in future addition sequences
e. Period of addition (present time to end of day, present time to x(i.e. 24) hours later)
f. Desired quantity of each respective addition of one or more materials to one or more units
g. Precision and accuracy requirement

The control module evaluates the parameters above and determines the optimal sequence and quantity of delivery to use for the delivery of a given material. The control module is placed on automatic control and the sequence of additions of the various input ports is commenced. For each addition from specific port, the following is an embodiment of an operation:
a. The system confirms all outlet and inlet ports/valves are closed. The computer then opens the desired inlet port valve and applies vacuum via a built-in eductor fitted with carrier air to fill the delivery vessel to the desired weight of a material. The control module monitors various factors related to the delivery such as valve position, rate of weight change, actual weight in vessel, etc. and modifies the valve position or other parameter which is capable of changing the rate of addition of a material such that the final weight in the vessel is close to the target weight. The actual weight in the vessel is then recorded and from which the quantity of material to be added during this sequence into the unit may be resolved.
b. The inlet ports/valves are closed and vacuum application to the vessel is stopped.
c. The vessel is pressurized using air or other pressurizing medium to the desired pressure.
d. Unit or units to which material is provided is selected.
e. The outlet port valve is opened and the catalyst is transferred directly into a unit via the transfer line.
f. The weight of the vessel is monitored to determine when the vessel is empty.
g. The application of the air/pressurizing medium is discontinued and the outlet valve is closed.
h. Any desired hold time is effected at this point as determined by the computer controller based on the evaluation parameters above.
i. The sequence above may be repeated for the next material/outlet port combination provided to one or more units.
j. If the material input is being tracked by the system, or other external monitoring device such as silo measuring device, then the material delivery system's control module may use this input to notify the operator that the vessel/container/silo is either nearing empty or is empty. Notification can be provided via email, wireless cellular, hard-wire Telco line, light on unit or in control room, siren, or many other notification means available in the art. If replacement of a container coupled to the vessel is required, the operation of the material delivery system or opening of a specific port may be temporarily suspended while the container is changed. Embodiments may include the ability for the operator to suspend either the entire system, or a specific port for bin/container changeout. In the case in which a specific port is suspended, the control module which keeps track of the quantity of catalyst taken from that specific container/bin can be re-set to zero.

The embodiments of the disclosed material delivery system include the ability to add one or more materials into two or more units based on desired metric of each material on some frequency basis (per hour, day, week). The control module can also be programmed such as to perform one or more the features, illustrated in examples below.

### Example 4

### Dependent or Independent relationship Between a Plurality of Materials Delivered to Respectively Same or Separate FCC Units

In an embodiment, material A is fresh FCC base catalyst added at a rate of 10 MT/day and material B, an additive such as sulfur oxide abatement additive i.e. Intercat Super SOXGETTER™, is added at a rate of 1 MT/day to the same unit 1. The above process description is set-up to perform this type of operation sequence. The control module is set to know that 10 MT/day of material A and 1 MT of material B needs to be delivered to the respective unit(s). If the amount of material A or B is changed, the control module may be programmed to maintain the relative proportion of material A to B.

1 Unit (such as FCC Unit)

In the 1 unit example, assume that material A is changed to 15 MT/day from the current 10 MT/day. If the 10% ratio of material B to material A is to be maintained, then the material delivery system needs to increase the addition of material B to 1.5 MT/day. The change may be performed manually, or the control module can make the calculation and make the change automatically.

1 Unit (such as Acrylonitrile Process Unit)

In an embodiment, material A such as BRXCAT™ is added at a rate of 115-130 lb/day and material B, Moly™, is added at a rate of 75-85 lb /day to the same unit 1. The above process description is set-up to perform this type of operation sequence. The control module is set to know that 115-130 lb/day of material A and 75-85 lb /day of material B is needs to be delivered to the respective unit. If the amount of material A or B is changed, the control module may be programmed to maintain the relative proportion of material A to B. In the 1 unit example, assume that material B is increased by 10%. If the ratio of material B to material A is to be maintained, then the material delivery system needs to increase the addition of material A in proportion to the increase in B. The change may be performed manually, or the control module can make the calculation and make the change automatically.

2 units

In an example of 2 separate units, a given material such as A or B may be changed independently of the other material that is delivered to 2 respectively separate units. For example, even though material A being delivered to unit 1 may be changed to 15 MT/day from the current 10 MT/day, amount of material B being delivered to unit 2 may be maintained as is.

### Example 5

### Automatically Adjusting Delivery of One or More Materials to Meet Specific Operating Parameters of One or more FCC Units

In some embodiments, specific operating parameters in one or more FCC units connected to a material delivery system are maintained by increasing or decreasing the delivery of one or more materials to the respective one or more FCC units.

In one embodiment, a refiner would like to maintain specific operating a specific level of sulfur dioxide (SO₂), to be emitted from one or more FCC units. The control module can make appropriate changes in the delivery rate of a sulfur oxide abatement additive to a plurality of units from a single delivery system based upon input from a sulfur dioxide meter to maintain SO₂ at a desired level, such as needed to comply with environmental protection agency regulations etc. The control module can make the appropriate changes on a routine, continual basis, or just during emergency peak periods, such as when the SO₂ level reaches a certain percentage of the maximum allowable emissions, for each respective FCC unit. In this way, the refinery can maintain compliance with SO₂ emissions while utilizing less sulfur oxide material (catalyst B) while not having to outlay the capital for a dedicated delivery system for each unit.

Another embodiment is maintaining performance of one or more units. Measured parameters such as but not limited to feed quality (feed API, metals content i.e. Nickel, Vanadium, Iron, Nitrogen, Sulfur) can have a major impact on an FCC unit performance, often measured by such parameters such as conversion or dry gas make. If one or more of these elements are expected, then the delivery rate of fresh catalyst can often be changed to mitigate or minimize the effect that any of these metals or other parameters may have on performance of the FCC unit. For instance, high nitrogen content in feed is known to poison the base FCC catalyst. If lab data on a specific feed of an FCC unit is known, then the control module of the material delivery system, either manually or automatically, can increase catalyst addition rates during this period for one or more FCC units. In a particular embodiment, changes in rate of delivery of a catalyst/material are automated as manpower on FCC unit is often limited. In an automated mode, lab data for feed nitrogen may be directly fed to the control module of the material delivery system and the delivery of a catalyst/material may be increased as the feed nitrogen increased, or decreased as the feed nitrogen decreased for one or more respective FCC units. This leads to an overall more consistent FCC operation, leading to increased profitability on the FCC unit. It should be appreciated that the material delivery system can increase or decrease the delivery of one or more materials and to one or more FCC units. For example, the material delivery system can increase or decrease the delivery of one or more materials such as sulfur oxide abatement additive and fresh catalyst to the same FCC unit or a plurality of different FCC units. The changes may be done manually, or the control module can make the calculation and make the change automatically.

The following Table 1 is an embodiment of some permutations of combinations of 4 types of materials which can be delivered to 2 units, respectively unit 1 and unit 2. There is virtually an infinite permutation of combinations of the type of materials and the respective quantities of a given material which can be delivered to one or more respective units, either individually or in a combination of two or more materials to one or more units thereof sequentially or simultaneously.

TABLE 1

| | unit | unit | unit | unit | unit | unit | unit | unit |
|---|---|---|---|---|---|---|---|---|
| Material A | 1 | 2 | 1 | 1 | 1 | 2 | 2 | 2 |
| fresh FCC | | | | | | | | |
| base catalyst | | | | | | | | |
| Material B | 1 | 2 | 1 | 1 | 2 | 1 | 2 | 2 |
| Sulfur oxide | | | | | | | | |
| abatement | | | | | | | | |
| additive | | | | | | | | |
| Material C | 1 | 2 | 1 | 2 | 2 | 1 | 2 | 2 |
| Material D | 1 | 2 | 2 | 2 | 2 | 1 | 1 | 1 |

### Example 6

### Acrylonitrile Process Unit

As another example, when the unit is an acrylonitrile process unit, the material flow rates may be in a range of 30-100 lb/day, but could be as high as 5000 lb/day during certain operations. Sometimes nitrogen is used as a carrier gas instead of air and in an embodiment, the delivery vessel may have an operational pressure in a range from about 0 to about 40 pounds per square inch. In another embodiment, the delivery vessel may have an operational pressure in a range from about 20 to about 40 pounds per square inch.

Although the teachings of the present invention have been shown and described in detail herein, those skilled in the art can readily devise other varied embodiments that still incorporate the teachings and do not depart from the scope and spirit of the invention.

While the invention has been described in detail in connection with only a limited number of aspects, it should be readily understood that the invention is not limited to such disclosed aspects. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A material delivery system comprising:
a delivery vessel configured to deliver material to at least one unit;
at least one dispense mechanism outlet configured to couple the delivery vessel to the at least one unit; and
with the proviso that when the unit is an FCC unit, the unit includes a plurality of units.

2. The material delivery system of claim 1, wherein the unit is selected from a group consisting of a unit for fluid catalyst cracking; unit for manufacture of pyridine and its derivatives, unit for manufacture of polypropylene, unit for manufacture of polyethylene, unit for manufacture of acrylonitrile, unit for cracking gasoline into LPG, and unit for cracking heavy feed into LPG.

3. The material delivery system of claim 1, wherein the delivery vessel is configured to deliver material to a plurality of units.

4. The material delivery system of claim 3, further comprising a plurality of dispense mechanisms respectively separately coupled to the plurality of units separately.

5. The material delivery system of claim 3, wherein at least one of the dispense mechanisms outlets is selectively coupled to the plurality of units.

6. The material delivery system of claim 1, further comprising a plurality of separate material storage containers coupled to the delivery vessel respectively via a plurality of inlets, a respective one of each inlet coupled to a separate material storage container.

7. The material delivery system of claim 1, further comprising
a separator disposed in the vessel and defining at least two compartments within the delivery vessel;
a plenum defined in the delivery vessel and fluidly coupled to each compartments; and
a plurality of outlet, a respective one of each outlets coupled to a respective compartment.

8. The material delivery system of claim 7, further comprising a plurality of load cells, respectively one of each load cells coupled to a respective compartment to provide a metric indicative of an amount of material dispensed from each compartment of the delivery vessel to the unit.

9. The material delivery system of claim 1, further comprising a device to minimize backflow from the at least one unit to the delivery vessel or from one unit to another unit.

10. The material delivery system of claim 1, wherein the material delivery system comprises self contained mobile material delivery system.

11. A method of providing material to at least one unit comprising:
dispensing material from a delivery vessel, wherein a metering device provides a metric indicative of the dispensed material with respect to the at least a unit, and
delivering the metered material to the at least one unit via at least one dispense mechanism outlet of the delivery vessel coupled to the at least one unit; with the proviso that when the unit is an FCC unit, the at least one dispense mechanism outlet of the delivery vessel are coupled to a plurality of units.

12. The method of claim 11, comprising sequentially delivering the metered metric of material to a first and second units by selectively coupling the dispense mechanism outlet to the first and second units.

13. The method of claim 11, comprising simultaneously dispensing the metered metric of material to a first and second units via a plurality of dispense mechanism outlets respectively coupled to the first and the second unit.

14. The method of claim 11, further comprising:
automatically updating a material available inventory information of a plant in a digital memory device in response to a predetermined event;
automatically determining a sufficiency of the material available inventory of the plant; and
optionally taking a re-supply action in response to a determination of insufficient material available inventory of the plant

15. The method of claim 11, further comprising:
determining an occurrence of a predefined event associated with the at least one unit;
establishing communication between a control module of the at least one unit and a remote device in response to the event, wherein the remote device is remote from the at least one unit; and
wherein the step of establishing communication comprises:
transmitting information to the remote device in response to a predefined event; and information comprises automatically submitting a reorder request for material if a material inventory level is below a predefined threshold; and transmitting information relating to the event between the remote device and control module.

16. The method of claim 11, further comprising:
wherein the material delivery system comprises a self contained mobile material delivery system.

17. The method of claim 11, further comprising
storing a record of system activity indicative of the amount of material in a memory device disposed in an enclosure suitable of hazardous duty; and
accessing the stored record from the enclosure while the enclosure remains sealed.

18. The method of claim 11, further comprising minimizing backflow from the at least one unit to the delivery vessel or from one unit to another unit.

19. A method of providing a material to a plurality of units comprising:
dispensing a metered metric of material from a delivery vessel to a first unit via a dispense mechanism outlet of a delivery vessel; and
dispensing a metered metric of material from the delivery vessel to a second unit via a dispense mechanism outlet of the delivery vessel.

20. The method of claim 19, wherein the unit comprises at least a unit selected from a group consisting of a unit for fluid catalyst cracking; unit for manufacture of pyridine and its derivatives, unit for manufacture of polypropylene, unit for manufacture of polyethylene, unit for manufacture of acrylonitrile, unit for cracking gasoline into LPG, and unit for cracking heavy feed into LPG.
